(19) United States
(12) Patent Application Publication
(10) Pub. No.: US 2026/0330072 A1
(43) Pub. Date: Oct. 22, 2026

(54) HUMAN-MACHINE INTERACTION SYSTEM WITH COMBINED PERSONNEL DETECTION AND ANTI-PEEP TOUCH DISPLAY FUNCTIONS

(71) Applicant: EMERGING DISPLAY TECHNOLOGIES CORP., Kaohsiung City (TW)

(72) Inventors: Chih Hung LU, Hualien City (TW); Wei Hao KAO, Kaohsiung City (TW); Po Tsun LIU, Kaohsiung City (TW); Chao Ping WU, Kaohsiung City (TW)

(21) Appl. No.: 19/366,097

(22) Filed: Oct. 22, 2025

(30) Foreign Application Priority Data
Apr. 18, 2025 (TW) 114114712

(51) Int. Cl. G06F 21/84; G06F 3/01

(52) U.S. Cl. CPC G06F 21/84; G06F 3/011

(57) ABSTRACT

A human-machine interaction system with combined personnel detection and anti-peep touch display functions comprises a controller, an object detection module for respectively detecting a distance and a direction of an object relative to and in front of the object detection module to generate an object sensing data, an anti-peep monitor, and a photographic device. The controller determines whether to switch the anti-peep monitor into an anti-peep mode and whether to turn on the photographic device to record. The controller executes a graphical interface application and determines a displaying content of the graphical interface application on the anti-peep touch monitor according to the object sensing data provided by the object detection module. Therefore, the present invention can appropriately protect information on the anti-peep touch monitor from being peeped by others when a user is operating the human-machine interaction system.

### CROSS REFERENCE TO RELATED APPLICATIONS

This application claims the priority to patent application No. 114114712 filed in Taiwan on Apr. 18, 2025, which is hereby incorporated in its entirety by reference into the present application.

### BACKGROUND OF THE INVENTION

### Field of the Invention

The present invention relates to a human-machine interaction system, especially a human-machine interaction system with combined personnel detection and anti-peep touch display functions.

### 2. Description of the Related Art

Nowadays, a human-machine interface with a display function can provide users with great user experience. Therefore, an entry access and control equipment with the human-machine interface and the display function is often used at an entrance of a building. For example, the entry access and control equipment with the human-machine interface and the display function installed at the entrance of a residence or a company can facilitate residents or company personnel to input passwords, communicate with visitors, etc. Moreover, the human-machine interface with a display function can be used at a self-service machine, wherein the self-service machine is configured for ordering, booking, shipping, picking up items, buying tickets, etc. Since the self-service machine or the entry access and control equipment is usually placed in a public space, how to prevent user information displayed on a monitor from being viewed by others when the self-service machine or the entry access and control equipment is operated is a problem to be solved.

### SUMMARY OF THE INVENTION

In view of the issues mentioned above, the present invention provides a human-machine interaction system with combined personnel detection and anti-peeping touch display functions, the system comprising:
a controller;
an object detection module connected with the controller and configured to detect a distance and a direction of an object relative to and in front of the object detection module to generate an object sensing data, and continuously transmitting the object sensing data to the controller;
an anti-peep touch monitor connected with the controller; and
a photographic device connected with the controller;
wherein the controller determines whether to control the anti-peep touch monitor to switch to an anti-peep mode and whether to control the photographic device to record images according to the object sensing data transmitted by the object detection module;
wherein the controller executes a graphical interface application and determines a displaying content of the graphical interface application on the anti-peep touch monitor according to the object sensing data transmitted by the object detection module.

In one embodiment, the present invention further provides a human-machine interaction system with combined personnel detection and anti-peep touch display functions, the system comprising:
a controller;
an object detection module connected with the controller and configured to respectively detect a distance and a direction of an object relative to the object detection module to generate an object sensing data, and continuously transmitting the object sensing data to the controller; and
an anti-peep touch monitor connected with the controller;
wherein the controller determines whether to control the anti-peep touch monitor to switch to an anti-peep mode according to the object sensing data transmitted by the object detection module;
wherein the controller executes a graphical interface application and determines a displaying content of the graphical interface application on the anti-peep touch monitor according to the object sensing data transmitted by the object detection module.

In one embodiment, when the controller does not detect any object (personnel) in the object sensing data, the controller turns off a backlight of the anti-peep touch monitor.

In one embodiment, when the controller determines that all distances between detected objects (personnel) and the object detection module in the object sensing data are greater than or equal to a first distance threshold, the controller turns off a backlight of the anti-peep touch monitor.

In one embodiment, when the controller determines that at least one distance between detected objects (personnel) and the object detection module in the object sensing data is less than or equal to a second distance threshold, the controller activates an operation screen on the graphical interface and switches the anti-peep touch display to the anti-peep mode.

In one embodiment, when the controller determines that at least one distance between detected objects (personnel) and the object detection module in the object sensing data is less than a first distance threshold and greater than a second distance threshold, the controller waits until a staying period has expired, and then when the controller confirms again that said at least one distance between the object (personnel) and the object detection module remains less than the first distance threshold and greater than the second distance threshold, the controller activates the graphical interface to display an alert image on the anti-peep touch monitor, wherein the second distance threshold is less than the first distance threshold.

In one embodiment, when the controller executes the graphical interface application to display an alert image on the anti-peep touch monitor, the controller determines whether at least one distance between detected objects (personnel) and the object detection module in the object sensing data is less than a first distance threshold and greater than a second distance threshold, and when the controller determines that at least one distance between detected objects (personnel) and the object detection module in the object sensing data is less than the first distance threshold and greater than the second distance threshold, the controller further determines a direction of the detected object (personnel) corresponding to the at least one distance, and the controller executes the graphical interface application to modify the alert image according to the direction of the object (personnel) and controls the anti-peep touch monitor to display the modified alert image; wherein the second distance threshold is less than the first distance threshold.

The human-machine interaction system with combined personnel detection and anti-peep touch display functions of the present invention can detect objects (personnel) within a specified range, as well as the distance and the direction of said object (personnel) relative to the object detection module to control whether the anti-peep touch monitor is to be switched to the anti-peep mode. Simultaneously, based on the detected objects (personnel) and their relative directions and distances to the object detection module, the system modifies the display contents of the graphical interface. This ensures that information displayed on the anti-peep touch monitor during operation of the human-machine interaction system with combined personnel detection and anti-peep touch display functions is appropriately protected from being viewed by others, thereby achieving the objective of the present invention.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1 illustrates a structural block diagram of a human-machine interaction system with combined personnel detection and anti-peep touch display functions of the present invention;

FIG. 2 illustrates a structural block diagram of an object detection module of the human-machine interaction system with combined personnel detection and anti-peep touch display functions of the present invention;

FIG. 3 illustrates a two-dimensional coordinate schematic of the human-machine interaction system with combined personnel detection and anti-peep touch display functions of the present invention;

FIG. 4 illustrates a structural block diagram of an anti-peep touch monitor of the human-machine interaction system with combined personnel detection and anti-peep touch display functions of the present invention;

FIG. 5 illustrates a flow chart of the human-machine interaction system with combined personnel detection and anti-peep touch display functions of the present invention;

FIG. 6 illustrates a schematic diagram of personnel detection of the human-machine interaction system with combined personnel detection and anti-peep touch display functions of the present invention;

FIG. 7 illustrates a schematic diagram of an operation screen of the human-machine interaction system with combined personnel detection and anti-peep touch display functions of the present invention;

FIG. 8 illustrates another schematic diagram of personnel detection of the human-machine interaction system with combined personnel detection and anti-peep touch display functions of the present invention;

FIG. 9 illustrates another schematic diagram of personnel detection of the human-machine interaction system with combined personnel detection and anti-peep touch display functions of the present invention;

FIG. 10 illustrates yet another schematic diagram of personnel detection of the human-machine interaction system with combined personnel detection and anti-peep touch display functions of the present invention; and

FIG. 11 illustrates a schematic diagram of an alert image of the human-machine interaction system with combined personnel detection and anti-peep touch display functions of the present invention.

### DETAILED DESCRIPTION OF THE INVENTION

The technical contents, features and effects of the present invention will be clearly presented in the following detailed description of the preferred embodiment with reference to the drawings. In addition, the directional terms mentioned in the following embodiments, such as: up, down, left, right, front, back, bottom, top, etc., are only relative directions with reference to the drawings, and do not represent absolute directional positions; therefore, the directional terms used are for the convenience of illustrating their relative positional relationships, and are not intended to impose limitations on the present invention.

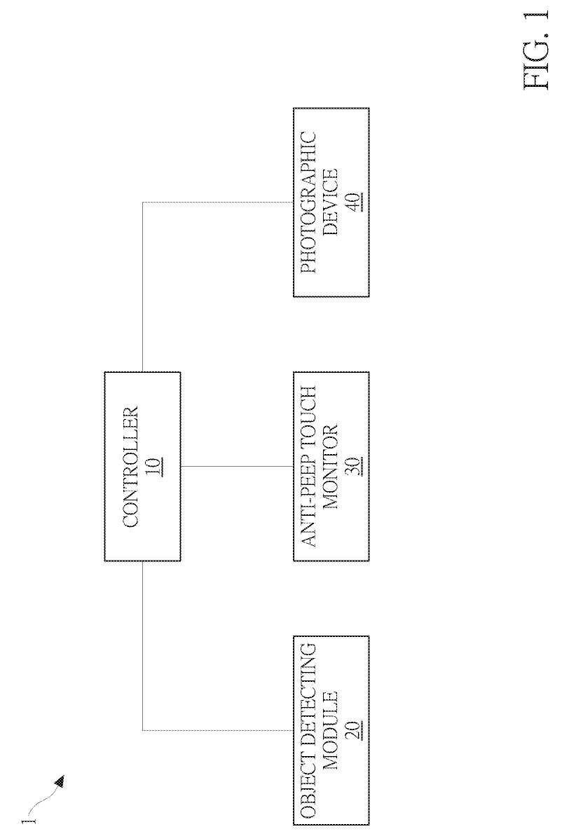

Referring to FIG. 1, a human-machine interaction system with combined personnel detection and anti-peep touch display functions 1 comprises a controller 10, an object detection module 20, an anti-peep touch monitor 30, and a photographic device 40, wherein the controller 10 is connected with the object detection module 20, the anti-peep touch monitor 30, and the photographic device 40. For example, the controller 10 can be a microcontroller unit (MCU), a central processing unit (CPU), a main board, a personal computer (PC), a cloud, etc. The present invention is not limited to the foregoing examples. The photographic device 40 is configured to record images.

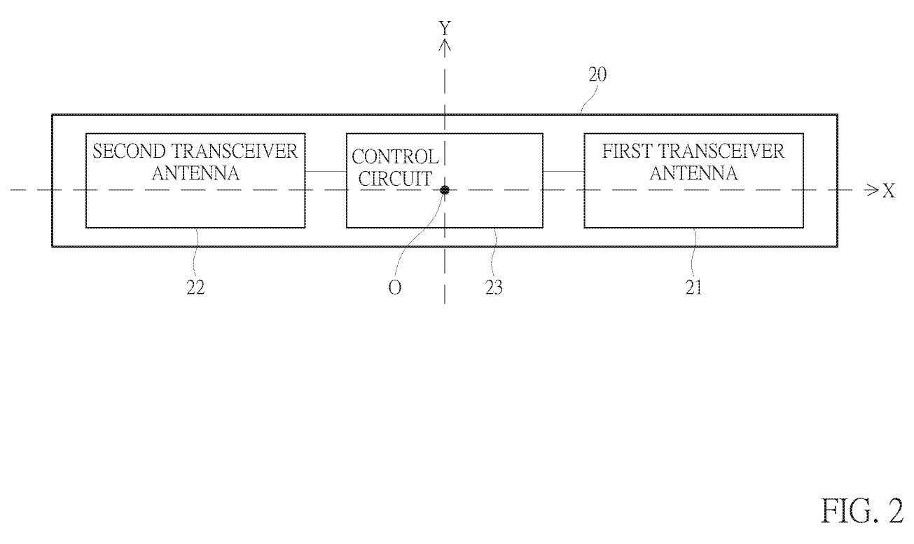

Referring to FIGS. 1 and 2, the object detection module 20 further comprises a first transceiver antenna 21, a second transceiver antenna 22, and a control circuit 23 connected with the first transceiver antenna 21 and the second transceiver antenna 22. The object detection module 20 is configured to respectively detect a direction and a distance of an object (person) relative to and in front of the object detection module 20 within an effective area (such as an effective semicircular area). Moreover, the object detection module 20 defines a two-dimensional coordinate system, and the two-dimensional coordinate system comprises an X-axis, a Y-axis, and an origin O, where the X-axis and the Y-axis intersect at the origin O. The X-axis and the Y-axis pass through the object detection module 20 and are perpendicular to each other. The first transceiver antenna 21 and the second transceiver antenna 22 are symmetrically arranged on opposite sides of the origin O. In one embodiment, the object detection module 20 comprises a system-on-chip (SOC) of an ultra-wideband (UWB) pulse radar transceiver, two 7.875GHz transmitters (TX), and two direct RF sampling receivers (RX). Values of effective detecting length for objects (personnel) are between 0.5 and 6 meters (relative to origin O), and values of the effective detecting angle are between 90 and -90 degrees based on the Y-axis and the origin O, wherein values of effective detecting length between 60 and -60 degrees are larger than the values of effective detecting length between 60 and 90 degrees and the values of effective detecting length between -60 and -90 degrees.

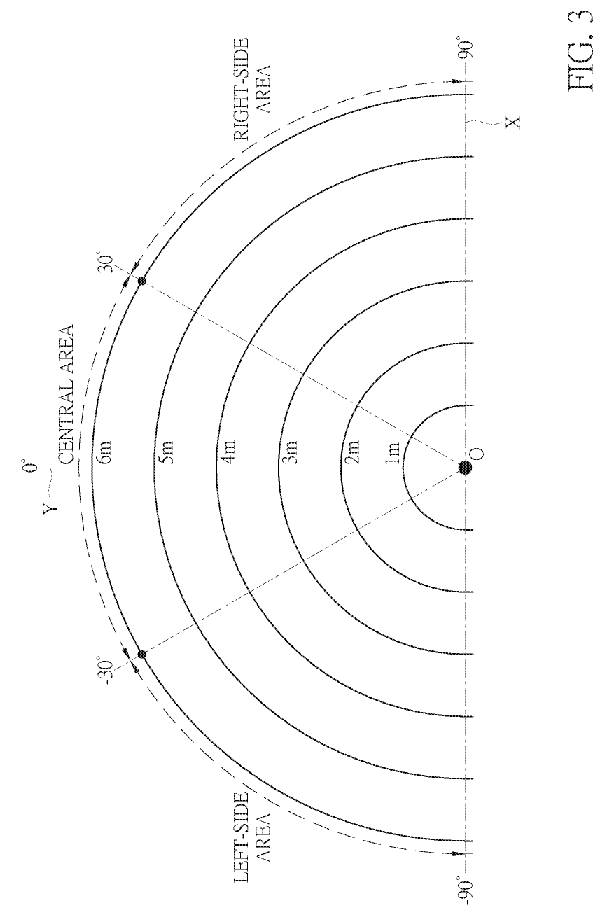

Referring to FIG. 3, multiple detecting semicircular areas are arranged in the two-dimensional coordinate system of the object detection module 20, wherein the multiple detecting semicircular areas have the origin O as a common circular center. The multiple detecting semicircular areas can be divided into a right-side area , a central area, and a left-side area, wherein the right-side area is defined as the partial area of the multiple detecting semicircular areas where values of the detecting angle are between 90 and 30 degrees, the central area is defined as the partial area of the multiple detecting semicircular areas where values of the detecting angle are between 30 and -30 degrees, and the left-side area is defined as the partial area of the multiple detecting semicircular areas where values of the detecting angle are between -30 and -90 degrees.

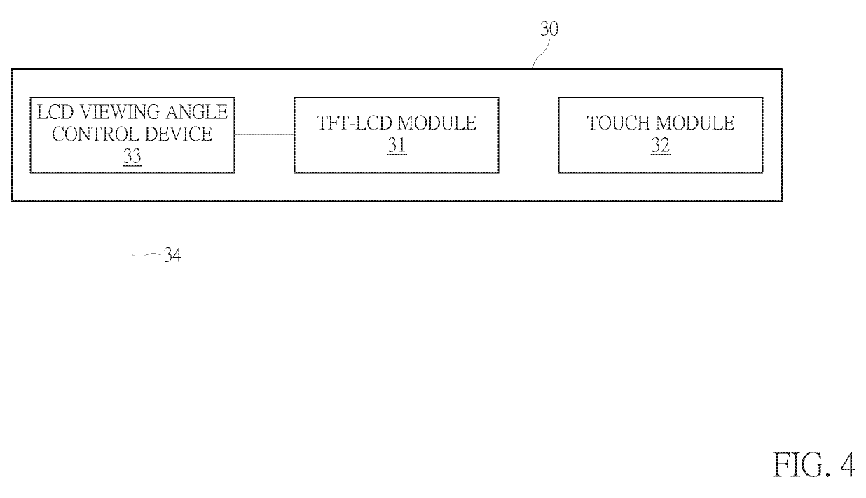

Referring to FIG. 4, the anti-peep touch monitor 30 comprises a thin film transistor liquid crystal display (TFT-LCD) module 31, a touch module 32, and an LCD viewing angle control device 33, wherein the LCD viewing angle control device 33 is connected with the TFT-LCD module 31 and is configured to control a viewing angle range of the TFT-LCD module 31. In particular, the controller 10 controls the anti-peep touch monitor 30 to enter an anti-peep mode through the LCD viewing angle control device 33. In one embodiment, the LCD viewing angle control device 33 has an anti-peep control terminal 34. The controller 10 controls the LCD viewing angle control device 33 via the anti-peep control terminal 34 to control the viewing angle range of the TFT-LCD module 31.

For example, when the LCD viewing angle control device 33 controls the viewing angle range of the TFT-LCD module 31 to be smaller (such as 17 degrees to -17 degrees horizontal viewing angle), the anti-peep touch monitor 30 enters the anti-peep mode. In the anti-peep mode, except for the user who is directly in front of the anti-peep touch monitor 30 (i.e. in the viewing angle range), other people who are near the anti-peep touch monitor 30, but outside the viewing angle range, cannot clearly see the content displayed on the anti-peep touch monitor 30.

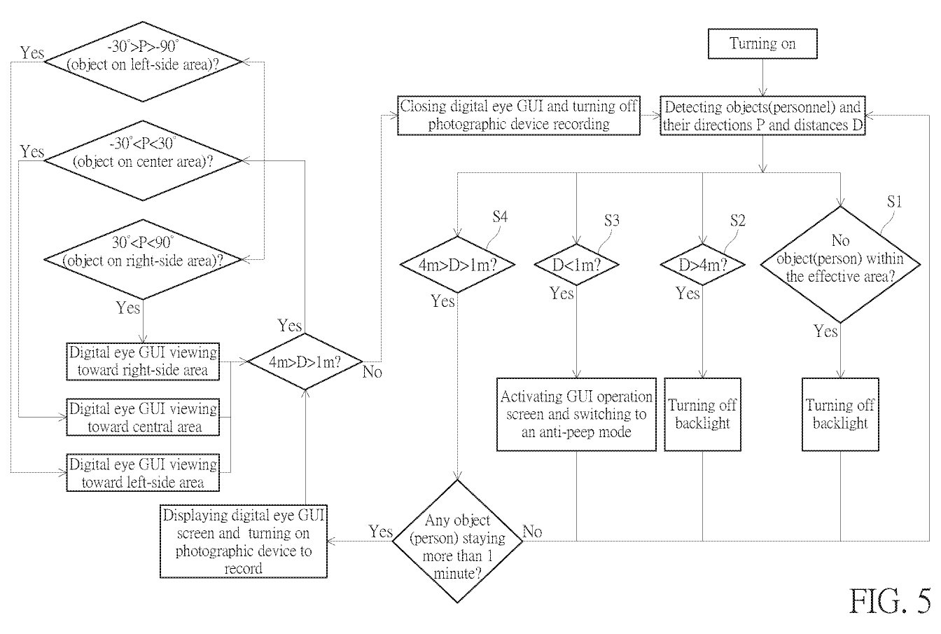

Referring to FIG. 5, FIG. 5 is a flow chart of a human-machine interaction system with combined personnel detection and anti-peep touch display functions 1 of the present invention. When turned on, the system performs an object detection step. That is, the object detection module 20 respectively detects a direction P and a distance D of an object (person) relative to the object detection module 20 within an effective area to generate an object sensing data, and respectively and continuously transmits the object sensing data to the controller 10. The controller 10 performs the following steps according to the object sensing data.

(S1): The controller 10 determines whether there is any object (person) within the effective area. When the controller 10 determines that there is no object (person) within the effective area, the controller 10 controls a backlight of the anti-peep touch monitor 30 to be turned off to save power and jumps back to the object detection step to receive the object sensing data.

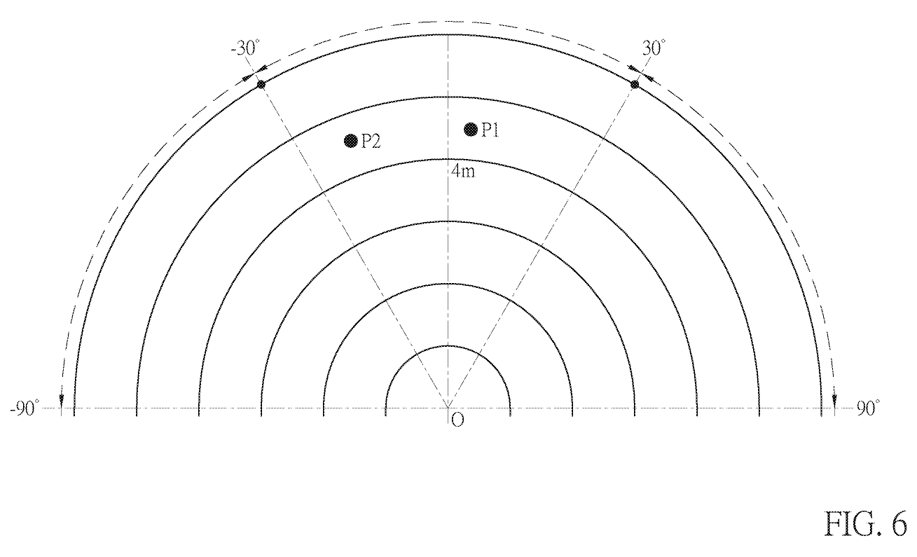

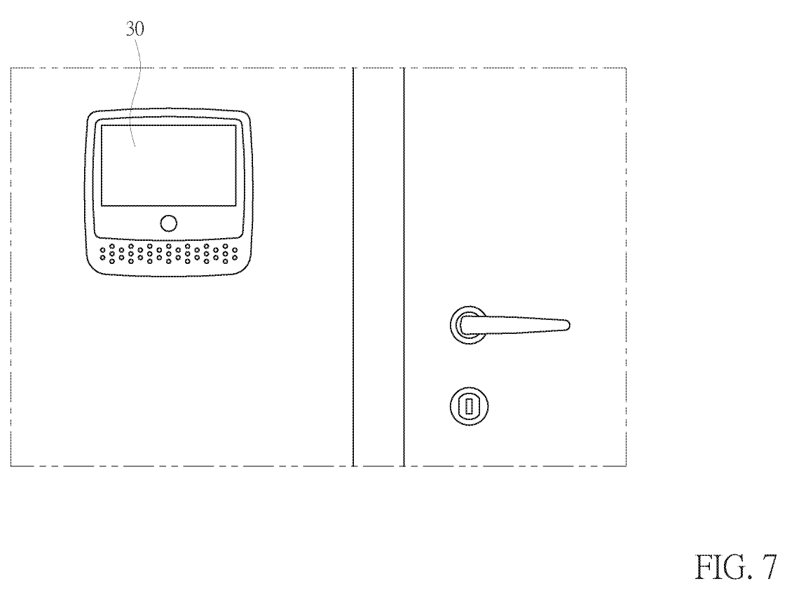

(S2): The controller 10 determines whether all distances D of the object sensing data are greater than or equal to a first distance threshold. When the controller 10 determines that all distances D of the object sensing data are greater than or equal to the first distance threshold (for example, a value of the first distance threshold is 4 meters), the controller 10 controls the backlight of the anti-peep touch monitor 30 to be turned off to save power and jumps back to the object detection step to receive the object sensing data. In this case, objects (personnel) within the effective area have no intention of approaching the system. For example, referring to FIGS. 6 and 7, the distances between a first object (person) P1 and the origin O, and between a second object (person) P2 and the origin O are both greater than 4 meters (i.e. the first distance threshold). Therefore, the controller 10 turns off the backlight of the anti-peep touch monitor 30.

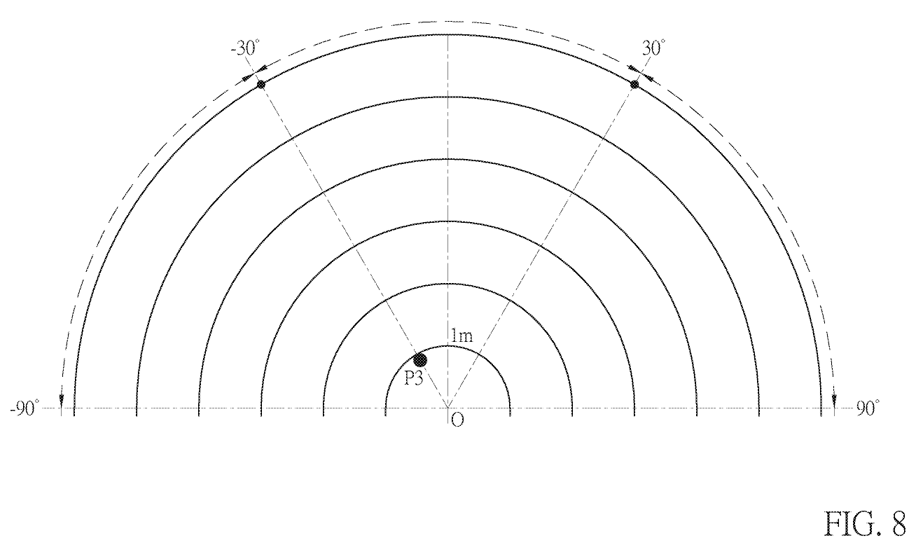

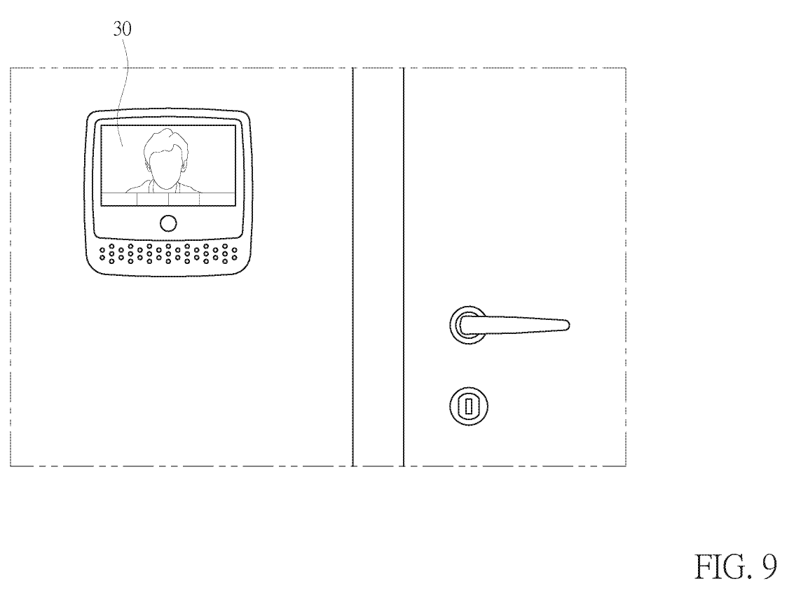

(S3) The controller 10 determines whether at least one distance D of the object sensing data is less than or equal to a second distance threshold. When the controller 10 determines that at least one distance D of the object sensing data is less than or equal to the second distance threshold (for example, a value of the second distance threshold is 1 meter), the controller 10 controls the backlight of the anti-peep touch monitor 30 to be turned on, activates a graphical interface application to display an operation interface on the anti-peep touch monitor 30, switches the anti-peep touch monitor 30 to the anti-peep mode via the anti-peep control terminal 34 and jumps back to the object detection step to receive the object sensing data. For example, referring to FIGS. 8 and 9, the distance D between a third object (person) P3 and the origin O is less than 1 meter (i.e. the second distance threshold). Therefore, the controller 10 turns on the backlight of the anti-peep touch monitor 30, activates the graphical interface application to display an operation interface on the anti-peep touch monitor 30, and switches the anti-peep touch monitor 30 to the anti-peep mode via the anti-peep control terminal 34.

(S4) The controller 10 determines whether at least one distance D of the object sensing data is less than the first distance threshold and greater than the second distance threshold, wherein the second distance threshold is less than the first distance threshold. When the controller 10 determines that at least one distance D of the object sensing data is less than the first distance threshold (e.g. 4 meters) and greater than the second distance threshold (e.g. 1 meter), it means that intention to operate the system of at least one object (person) who is corresponding to the at least one distance (denoted as a staying object or person) is uncertain. Therefore, after a staying period, such as one minute, the controller 10 determines again whether the object (person) staying remains, and if the controller 10 determines that the staying object (person) no longer remains, the controller 10 jumps back to the object detection step to receive the object sensing data.

Following on from the foregoing, on the other hand, if the controller 10 determines that the staying object (person) remains after the staying period, such as one minute, it means the staying object (person) continues to stay, then the controller 10 executes the graphical interface application to display an alert image , e.g. a digital eye graphical user interface (GUI), on the anti-peep touch monitor 30, and then the controller 10 turns on the photographic device 40 to record images to monitor the staying object (person).

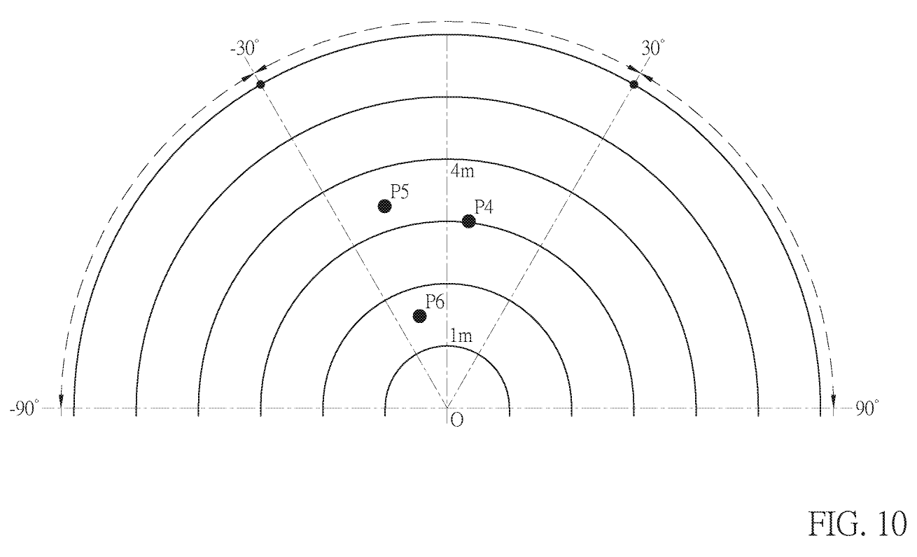

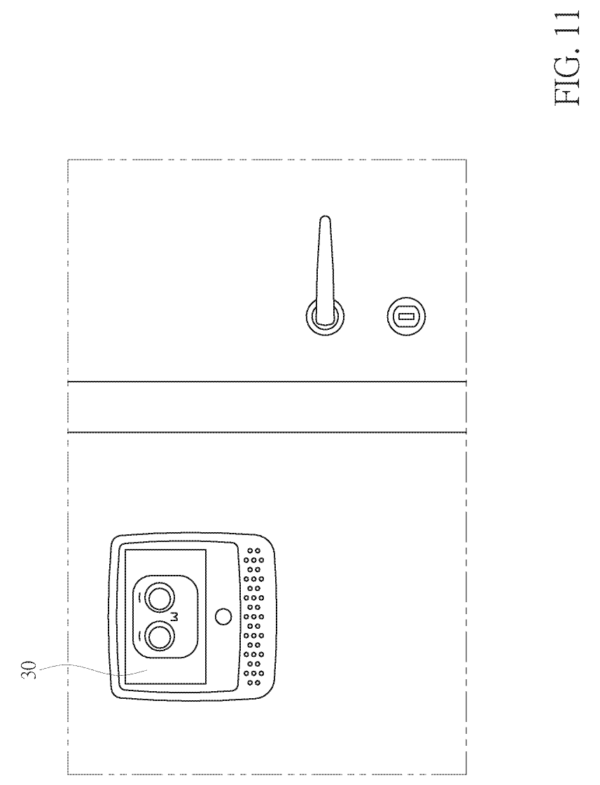

In one embodiment, referring to FIGS. 10 and 11, the distances D between a fourth object (person) P4 and the origin O, a fifth object (person) P5 and the origin O, a sixth object (person) P6 and the origin O are all less than 4 meters (i.e. the first distance threshold) and greater than 1 meter (i.e. the second distance threshold). Therefore, the controller 10 turns on the backlight of the anti-peep touch monitor 30 and executes the graphical interface application to display the digital eye graphical user interface (i.e. the alert image) on the anti-peep touch monitor 30.

Following on from the foregoing, then the controller 10 determines again whether the staying object (person) remains based on the object sensing data. When the controller 10 determines that there is no staying object (person), the controller 10 controls the backlight of the anti-peep touch monitor 30 to be turned off and the photographic device 40 to be turned off to save power. Then, the system is back to the object detection step to receive the object sensing data. On the other hand, when the controller 10 determines that the staying object (person) remains, the controller 10 determines the area in which the staying object (person) is located according to the object sensing data, such as the right-side area (values of the detecting angle are between 90 and 30 degrees), the central area (values of the detecting angle are between 30 and -30 degrees), and the left-side area (values of the detecting angle are between -30 and -90 degrees). And simultaneously, the controller 10 also controls the photographic device 40 to record images to monitor the staying object (person). And then, the controller 10 executes the graphical interface application to modify the alert image according to the area that the staying object (person) is located and controls the anti-peep touch monitor 30 to display the alert image that has been modified. For example, if the area where the staying object (person) is located is the left-side area, the controller 10 modifies the digital eye graphical user interface and controls the anti-peep touch monitor 30 to display the digital eye graphical user interface viewing toward the left-side area (not shown in drawings); if the area where the staying object (person) is located is the central area, the controller modifies the digital eye graphical user interface and controls the anti-peep touch monitor 30 to display the digital eye graphical user interface viewing toward the central area (e.g. alert image of FIG. 11); if the area where the staying object (person) is located is the right-side area, the controller modifies the digital eye graphical user interface and controls the anti-peep touch monitor 30 to display the digital eye graphical user interface viewing toward the right-side area (not shown in drawings). Therefore, the staying object (person) is reminded that the system is watching them as well as the system is equipped with security functions.

Although the present invention has been disclosed as above by way of a preferred embodiment, it is not intended to limit the present invention, and any one skilled in the art may make certain changes and modifications without departing from the spirit and scope of the present invention, and therefore the scope of protection of the present invention shall be subject to the scope of the appended patent claims as defined herein.

What is claimed is:

1. A human-machine interaction system with combined personnel detection and anti-peep touch display functions, the system comprising:
a controller;
an object detection module connected with the controller and configured to respectively detect a distance and a direction of an object relative to the object detection module to generate an object sensing data, and continuously transmitting the object sensing data to the controller;
an anti-peep touch monitor connected with the controller; and
a photographic device connected with the controller;
wherein the controller determines whether to switch the anti-peep touch monitor into an anti-peep mode and whether to control the photographic device to record images according to the object sensing data transmitted by the object detection module;
wherein the controller executes a graphical interface application and determines a displaying content of the graphical interface application on the anti-peep touch monitor according to the object sensing data provided by the object detection module.

2. The system as claimed in claim 1, wherein, when the controller determines that at least one distance between detected objects (personnel) and the object detection module in the object sensing data is less than a first distance threshold and greater than a second distance threshold, the controller waits until a staying period has expired, and then when the controller confirms again that said at least one distance between the objects (personnel) and the object detection module remains less than the first distance threshold and greater than the second distance threshold, the controller activates the graphical interface to display an alert image on the anti-peep touch monitor and controls the photographic device to record images, wherein the second distance threshold is less than the first distance threshold.

3. The system as claimed in claim 1, wherein, when the controller executes the graphical interface application to display an alert image on the anti-peep touch monitor and turns on the photographic device to record images, the controller determines whether at least one distance between detected objects (personnel) and the object detection module in the object sensing data is less than a first distance threshold and greater than a second distance threshold, and when the controller confirms that the at least one distance between detected objects (personnel) and the object detection module is less than the first distance threshold and greater than the second distance threshold, the controller further determines a direction of the detected object (person) corresponding to the at least one distance, and the controller executes the graphical interface application to modify the alert image according to the direction of the object (person), and controls the anti-peep touch monitor to display the modified alert image; wherein the second distance threshold is less than the first distance threshold.

4. The system as claimed in claim 1, wherein, when the controller executes the graphical interface application to display an alert image on the anti-peep touch monitor and turns on the photographic device to record images, the controller determines whether at least one distance between detected objects (personnel) and the object detection module in the object sensing data is less than a first distance threshold and greater than a second distance threshold, and when the controller determines that no distance between detected object (person) and the object detection module is less than the first distance threshold and greater than the second distance threshold; the controller turns off a backlight of the anti-peep touch monitor and the photographic device.

5. A human-machine interaction system with combined personnel detection and anti-peep touch display functions, the system comprising:
a controller;
an object detection module connected with the controller and configured to respectively detect a distance and a direction of an object relative to the object detection module to generate an object sensing data, and continuously transmitting the object sensing data to the controller; and
an anti-peep touch monitor connected with the controller;
wherein the controller determines whether to switch the anti-peep touch monitor into an anti-peep mode according to the object sensing data transmitted by the object detection module;
wherein the controller executes a graphical interface application and determines a displaying content of the graphical interface application on the anti-peep touch monitor according to the object sensing data provided by the object detection module.

6. The system as claimed in claim 5, wherein, when the controller determines that at least one distance between detected objects (personnel) and the object detection module in the object sensing data is less than a first distance threshold and greater than a second distance threshold, the controller waits until a staying period has expired, and then when the controller confirms again that said at least one distance between the objects (personnel) and the object detection module remains less than the first distance threshold and greater than the second distance threshold, the controller activates the graphical interface to display an alert image on the anti-peep touch monitor, wherein the second distance threshold is less than the first distance threshold.

7. The system as claimed in claim 5, wherein, when the controller executes the graphical interface application to display an alert image on the anti-peep touch monitor, the controller determines whether at least one distance between detected objects (personnel) and the object detection module in the object sensing data is less than a first distance threshold and greater than a second distance threshold, and when the controller confirms that at least one distance between detected objects (personnel) and the object detection module in the object sensing data is less than the first distance threshold and greater than the second distance threshold, the controller further determines a direction of the detected object (person) corresponding to the at least one distance, and the controller executes the graphical interface application to modify the alert image according to the direction of the object (person), and controls the anti-peep touch monitor to display the modified alert image; wherein the second distance threshold is less than the first distance threshold.

8. The system as claimed in claim 5, wherein, when the controller executes the graphical interface application to display an alert image on the anti-peep touch monitor, the controller determines whether at least one distance between detected objects (personnel) and the object detection module in the object sensing data is less than a first distance threshold and greater than a second distance threshold, and when the controller determines that no distance between detected objects (personnel) and the object detection module is less than the first distance threshold and greater than the second distance threshold; the controller turns off a backlight of the anti-peep touch monitor.

9. The system as claimed in claim 5, wherein, when the controller does not detect any object (person) in the object sensing data, the controller turns off a backlight of the anti-peep touch monitor.

10. The system as claimed in claim 5, wherein, when the controller determines that all distances between detected objects (personnel) and the object detection module in the object sensing data are greater than or equal to a first distance threshold, the controller turns off a backlight of the anti-peep touch monitor.

11. The system as claimed in claim 5, wherein, when the controller determines that at least one distance between detected objects (personnel) and the object detection module in the object sensing data is less than or equal to a second distance threshold, the controller activates an operation screen on the graphical interface and switches the anti-peep touch display to the anti-peep mode.

12. The system as claimed in claim 5, wherein, the direction of the object (person) of the object sensing data falls into a right-side direction, a central direction, or a left-side direction.

13. The system as claimed in claim 5, wherein, the anti-peep touch monitor comprises a thin film transistor liquid crystal display (TFT-LCD) module, a touch module, and a viewing angle control device integrated with each other; the viewing angle control device is connected with the TFT-LCD module and is configured to control a viewing angle range of the TFT-LCD module.

14. The system as claimed in claim 5, wherein, the anti-peep touch monitor also has an anti-peep control terminal; the controller controls whether the anti-peeping touch display is switched to an anti-peeping mode via the anti-peeping control terminal.

15. The system as claimed in claim 5, wherein, the object detection module comprises a first transceiver antenna, a second transceiver antenna, and a control circuit connected with the first transceiver antenna and the second transceiver antenna;
the object detection module is configured to respectively detect the direction and the distance of the object relative to the object detection module within a semicircular area.

16. The system as claimed in claim 12, wherein, the right-side direction is 90 to 30 degrees in a two-dimensional coordinate system based on the object detection module;
the central direction is 30 to -30 degrees in the two-dimensional coordinate system based on the object detection module;
the left-side direction is -30 to -90 degrees in the two-dimensional coordinate system based on the object detection module.
